(19) United States
(12) Patent Application Publication
(10) Pub. No.: US 2024/0247817 A1
(43) Pub. Date: Jul. 25, 2024

(54) Air Conditioning System

(71) Applicant: Hitachi Global Life Solutions, Inc., Minato-ku, Tokyo (JP)

(72) Inventors: Noritoshi NISHIMURA, Tokyo (JP); Nobuhiro IMAGUCHI, Tokyo (JP); Kazuhito MATSUZAKI, Tokyo (JP); Yuuiti SATO, Tokyo (JP)

(21) Appl. No.: 18/562,476

(22) PCT Filed: Jun. 4, 2021
(86) PCT No.: PCT/JP2021/021407

§ 371 Date: Nov. 20, 2023

(51) Int. Cl. F24F 3/167; F24F 7/06; F24F 11/77; F24F 110/40

(52) U.S. Cl. CPC F24F 3/167; F24F 7/06; F24F 11/77; F24F 2110/40

(57) ABSTRACT

Provided is a user-friendly air conditioning system. An air conditioning system comprises: a fan filter unit that has an air supply fan for supplying air to a clean room; and a fan filter unit that has an air return fan for returning or the like of air from the clean room. The air conditioning system further comprises: a pressure sensor that is installed in the clean room; and a control device that controls one of the air supply fan and the air return fan on the basis of the detection value of the pressure sensor, and controls the other fan at a constant speed. It is possible to switch between controlling one of the air supply fan and the air return fan on the basis of the detection value of the pressure sensor and the other fan at a constant speed.

### TECHNICAL FIELD

The present invention relates to an air conditioning system.

### BACKGROUND ART

A clean room with a high degree of air cleanliness is used in regenerative medicine, production of drugs, manufacturing of semiconductors and precision instruments, and the like. For example, a technique described in Patent Literature 1 is known regarding room pressure adjustment of such a clean room. Specifically, Patent Literature 1 describes “individually controls the air supply fans 22 of the respective FFUs 20 such that the pressure difference measured by the pressure difference meter 25 is maintained within a predetermined range”.

### CITATION LIST

### Patent Literature

Patent Literature 1: Japanese Patent Application Publication No. 2000-337675

### SUMMARY OF INVENTION

### Technical Problem

In the technique described in Patent Literature 1, the air supply fans are individually controlled while rotation speeds of air discharge fans are not adjusted particularly. Accordingly, in the technique described in Patent Literature 1, it is difficult to, for example, use a clean room that has been used as a negative pressure room up to this point, as a positive pressure room in a different application.

Accordingly, an object of the present invention is to provide an air conditioning system with good usability.

### Solution to Problem

In order to solve the above problem, an air conditioning system according to the present invention includes: a first unit including a first fan that performs air supply to a clean room; a second unit including a second fan that performs at least one of air discharge and air return from the clean room; a pressure sensor provided in the clean room; and a controller that controls one of the first fan and the second fan based on a detection value of the pressure sensor and controls the other one of the first fan and the second fan at a constant speed, and the fan controlled based on the detection value of the pressure sensor and the fan controlled at the constant speed out of the first fan and the second fan are switchable. Other points are described in the embodiments.

### Advantageous Effects of Invention

The present invention can provide an air conditioning system with good usability.

### BRIEF DESCRIPTION OF DRAWINGS

FIG. 1 is an explanatory diagram showing a layout of rooms of an air conditioning system according to a first embodiment.

FIG. 2 is an explanatory diagram showing arrangement and the like of multiple fan filter units included in the air conditioning system according to the first embodiment.

FIG. 3 is an explanatory diagram showing the arrangement and the like of the multiple fan filter units included in the air conditioning system according to the first embodiment.

FIG. 4 is an explanatory diagram of the air conditioning system according to the first embodiment.

FIG. 5 is a configuration diagram relating to control of a fan filter unit on the air supply side and a fan filter unit on the air return side included in the air conditioning system according to the first embodiment.

FIG. 6 is a characteristic diagram showing a relationship between rotation speed and an air volume of an air return fan included in the air conditioning system according to the first embodiment.

FIG. 7 is an explanatory diagram of an air conditioning system according to a second embodiment.

### DESCRIPTION OF EMBODIMENTS

### First Embodiment

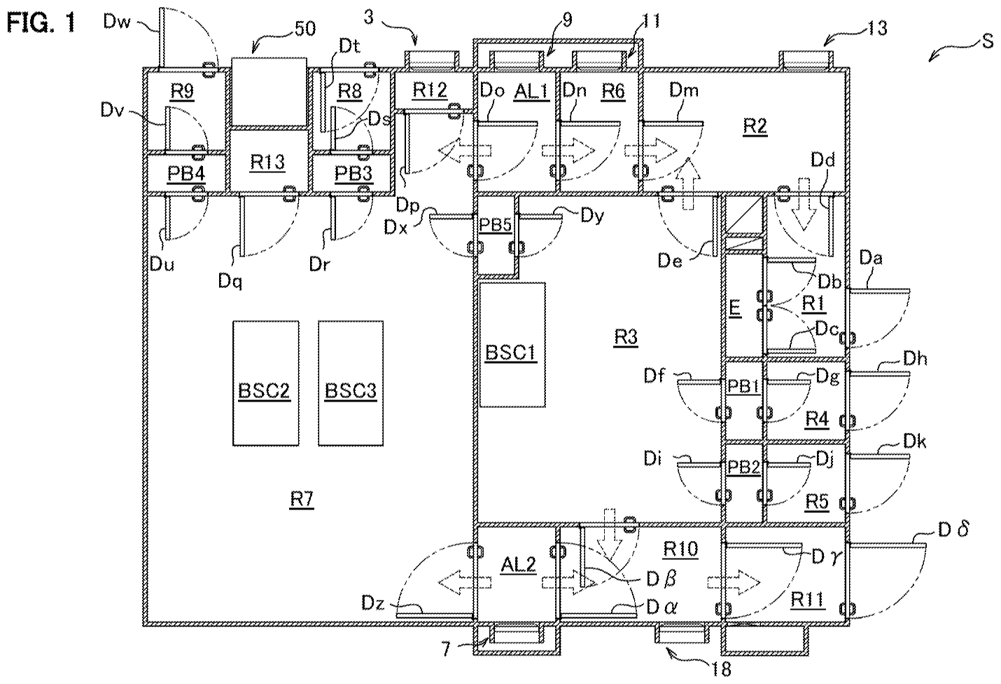

FIG. 1 is an explanatory diagram showing a layout of rooms of an air conditioning system S according to a first embodiment.

Note that, in FIG. 1, a direction of an air flow in a case where a predetermined door (for example, door Dm) is opened is shown by an arrow outlined by a broken line. In the first embodiment, room pressure adjustment of each of clean rooms is mainly described. However, cases where temperature and humidity of air are adjusted in addition to room pressure are also assumed to be included in “air conditioning”. Moreover, adjustment of only the room pressure is also assumed to be included in “air conditioning”.

The air conditioning system S is a system that adjusts room pressures of multiple clean rooms such as a preprocessing room R3 and a preparation room R7, and is provided in, for example, a regenerative medicine facility. In such an air conditioning system S, multiple rooms varying in a degree of cleanliness of air are provided in many cases. A difference in the room pressure is provided between adjacent rooms to suppress leakage of air from a room with a lower degree of cleanliness to a room with a higher degree of cleanliness.

One example of this case is given. The preprocessing room R3 shown in FIG. 1 has a higher degree of air cleanliness than a first changing room R2, and the room pressure of the preprocessing room R3 is higher. Accordingly, when a worker opens a door De to enter the preprocessing room R3 from the first changing room R2, air flows in from the preprocessing room R3 on the high pressure side to the first changing room R2 on the low pressure side as shown by the broken line arrow in FIG. 1, but a flow in the opposite direction hardly occurs. Entrance of dust from the first changing room R2 into the preprocessing room R3 is thereby suppressed, and the degree of cleanliness of the preprocessing room R3 is maintained.

However, the above movement of air temporarily increases the room pressure of the first changing room R2 while temporarily reducing the room pressure of the preprocessing room R3. Such changes in the room pressures occur every time the door De is opened and closed. Accordingly, in the first embodiment, each of devices to be described later is controlled to suppress the changes in the room pressures of the respective clean rooms.

Note that, in FIG. 1, each of portions where the arrow outlined by the broken line and heading from one of the two adjacent clean rooms to the other is shown is assumed to be a portion where the room pressure of the above one clean room is higher than the room pressure of the other clean room. Moreover, description of some of the multiple clean rooms and doors denoted by reference signs in FIG. 1 is omitted as appropriate. For example, description of some of the multiple doors Da to Dz, Da, DB, Dy, and Do are omitted.

In the example of FIG. 1, a dressing-undressing room R1, the first changing room R2, the preprocessing room R3, an undressing room R10, and a pre-clean room R11 are provided adjacent to one another in this order. For example, when the worker is to perform work in the preprocessing room R3, the worker passes through the clean rooms in the order described above. A biohazard cabinet BSC1 for handling predetermined specimens is provided in the preprocessing room R3. The specimens used in the biohazard cabinet BSC1 are taken in by being sequentially passed through a pre-clean room R4 and a pass box PB1. Meanwhile, products (cell processed products or the like) created in the biohazard cabinet BSC1 are taken out by being sequentially passed through a pass box PB2 and a pre-clean room R5. Note that the pass boxes PB1 and PB2 are spaces for suppressing contamination (specimen contamination).

Moreover, the dressing-undressing room R1, the first changing room R2, a second changing room R6, an air lock AL1, the preparation room R7, an air lock AL2, the undressing room R10, and the pre-clean room R11 are provided adjacent to one another in this order. For example, when the worker is to perform work in the preparation room R7, the worker passes through the clean rooms in the order described above. The air locks AL1 and AL2 are spaces for suppressing entrance of dust into the preparation room R7 with a high degree of cleanliness, and the room pressures of the air locks AL1 and AL2 are higher than those of the other clean rooms.

Moreover, specimens and the like can be taken in and out between the preparation room R7 and the preprocessing room R3 through a pass box PB5. The degree of cleanliness of the preparation room R7 is higher than that of the preprocessing room R3, and the room pressure of the preparation room R7 is also higher than that of the preprocessing room R3. Contamination (specimen contamination) in the case where the door Dx or the door Dy is opened can be thereby suppressed.

In the example of FIG. 1, biohazard cabinets BSC2 and BSC3 for handling predetermined specimens are provided in the preparation room R7. Products (cell processed products or the like) created in the biohazard cabinets BSC2 and BSC3 are taken out by being sequentially passed through a pass box PB3 and a pre-clean room R8. Meanwhile, wastes and the like are taken out by being sequentially passed through a pass box PB4 and a pre-clean room R9.

Note that each of the dressing-undressing room R1, the first changing room R2, the preprocessing room R3, the pre-clean rooms R4 and R5, the second changing room R6, the preparation room R7, the pre-clean rooms R8 and R9, the undressing room R10, the pre-clean room R11, and the air locks AL1 and AL2 shown in FIG. 1 corresponds to the “clean room”. Moreover, fan filter units 3, 7, 9, 11, 13, 18 and an air handling unit 50 shown in FIG. 1 are described later.

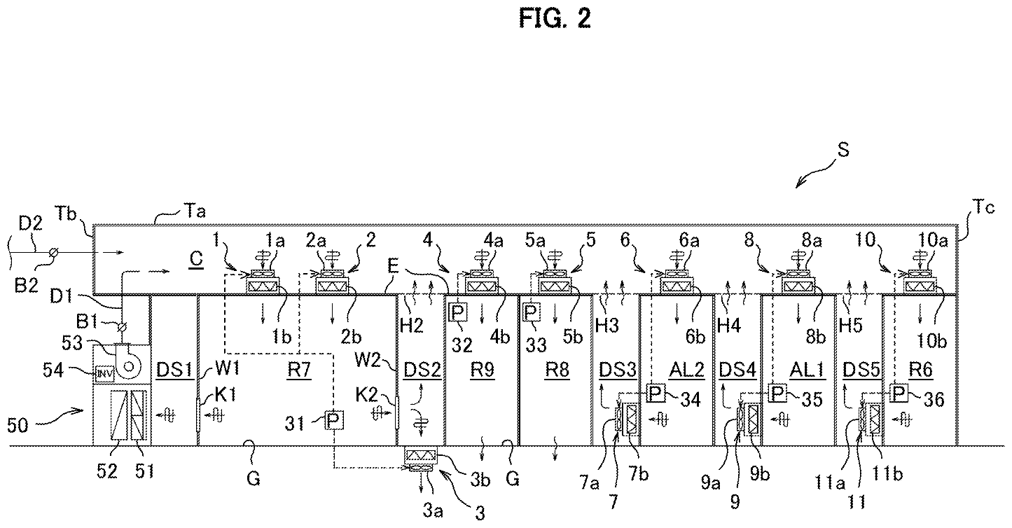

FIG. 2 is an explanatory diagram showing arrangement and the like of multiple fan filter units.

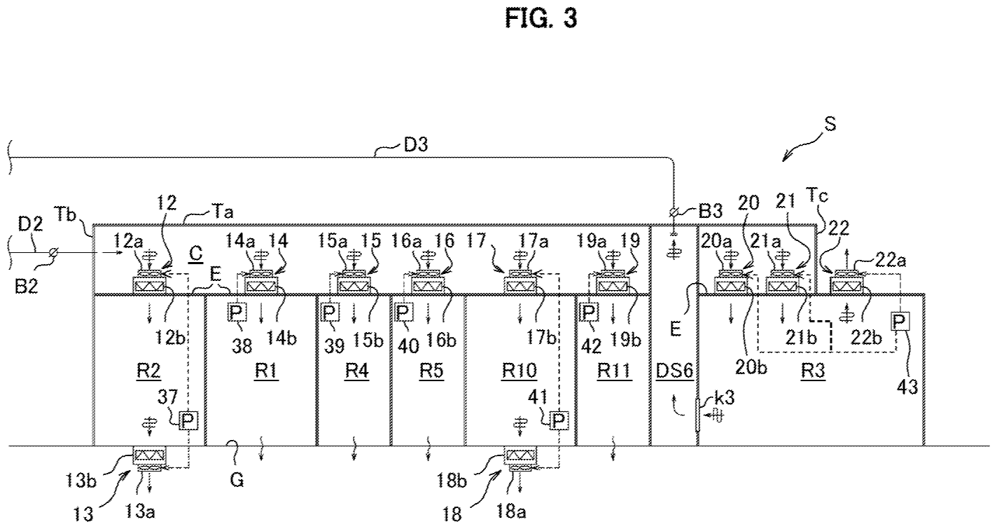

Note that, in FIG. 2, air flows are shown by solid line arrows while signal lines are shown by broken line arrows. Furthermore, FIG. 2 shows some of the clean rooms in FIG. 1 (layout diagram), and FIG. 3 shows the other clean rooms. FIGS. 2 and 3 are schematic cross-sectional diagrams focusing on air flows such as, for example, air is guided from the preparation room R7 to a chamber C via a duct shaft DS2.

A duct shaft DS1 shown in FIG. 2 is not shown in FIG. 1, but is a space that guides air from the preparation room R7 to the chamber C. Moreover, other duct shafts DS2 to D5 are also not shown in FIG. 1, but are spaces that guide air from predetermined clean rooms to the chamber C. These duct shafts DS1 to DS5 are air guide pipes (not shown) provided in gaps between adjacent clean rooms and the like.

As shown in FIG. 2, the air conditioning system S includes the air handling unit 50, fan filter units 1 to 11, and pressure sensors 31 to 36.

The air handling unit 50 is a device that adjusts temperature and the like of air. As shown in FIG. 2, the air handling unit 50 includes a filter 51, a cooling coil 52, a fan 53, and an inverter 54.

The filter 51 collects dust from air flowing from the preparation room R7 toward the cooling coil 52 via the duct shaft DS1. The cooling coil 52 is a heat exchanger in which heat exchange is performed between air passing the filter 51 and coolant flowing through a heat transmission pipe (not shown). The fan 53 is an air blower that pumps air subjected to the heat exchange in the cooling coil 52 to the chamber C via a duct D1. The inverter 54 controls a motor (not shown) of the fan 53.

As shown in FIG. 2, a blow out port of the fan 53 and the chamber C are connected via the duct D1. The duct D1 is an air guide pipe that guides air whose temperature and the like are adjusted in the air handling unit 50, to the chamber C. A damper B1 is provided in this duct D1. For example, the damper B1 is set to a predetermined opening degree in a test operation of the air conditioning system S, and is maintained at the above predetermined opening degree during an air conditioning operation after the test operation. Moreover, air whose temperature and the like are adjusted is guided to the chamber C via another duct D2, as well as the duct D1. The air supplied via the duct D1 and the air supplied via the duct D2 thereby merge in the chamber C.

The chamber C is a space above ceilings of the respective clean rooms such as the preparation room R7. Specifically, the chamber C is configured by including ceilings E of the respective clean rooms such as the preparation room R7, an upper plate Ta, and side plates Tb and Tc. In the example of FIG. 2, the upper plate Ta is provided at a position above the ceilings E, and a plate surface of the upper plate Ta is substantially parallel to surfaces of the ceilings E. Moreover, the side plate Tb is provided to connect edges of the ceiling E and the upper plate Ta on one side in a horizontal direction. Similarly, the side plate Tc is provided to connect edges of the ceiling E and the upper plate Ta on the other side in the horizontal direction.

As shown in FIG. 2, the space above the ceilings of the respective clean rooms is formed as one chamber C (common space). The air whose temperature and the like are adjusted as predetermined is guided to the chamber C, and is then guided from the chamber C to the preparation room R7 by the fan filter units 1 and 2 (first filter unit) on the air supply side. Note that the same applies to the other clean rooms. Moreover, clean rooms with different target pressures (set pressures) of the room pressure are included in the multiple clean rooms in a mixed manner.

According to such a configuration, there is no need to particularly provide ducts that guide air to the fan filter units 1 and 2 and the like for the chamber C (or to provide ducts instead of the chamber C). Accordingly, the configuration of the air conditioning system S can be simplified. Thus, work of providing gas pipes and drawing communication lines and electric power lines in the chamber C is facilitated, and cost can be also reduced.

The fan filter unit 1 (first unit) shown in FIG. 2 is a device that performs air supply from the chamber C to the preparation room R7, and is embedded in the ceiling E. The fan filter unit 1 includes an air supply fan 1a (first fan) and a filter 1b. The air supply fan 1a is an air blower that performs air supply from the chamber C to the preparation room R7 (clean room). As shown in FIG. 2, the suction side of the air supply fan 1a communicates with the chamber C (common space).

The filter 1b is a filter that collects dust from air flowing from the air supply fan 1a toward the preparation room R7, and is provided on the blow-out side of the air supply fan 1a. For example, a HEPA (high efficiency particulate air filter) or a ULPA (ultra low penetration air filter) is used as the filter 1b described above. A case (not shown) that houses the air supply fan 1a and the filter 1b is fitted to an opening portion in the ceiling E of the preparation room R7, and is fixed with a clasp or the like. Note that the other fan filter unit 2 provided in the ceiling E of the preparation room R7 also has the same configuration as the fan filter unit 1 described above.

The fan filter unit 3 (second unit) shown in FIG. 2 is a device that performs air discharge and air return from the preparation room R7. Note that “air return” from the preparation room R7 means returning at least part of air flowing out from the preparation room R7 to the preparation room R7. Moreover, although the fan filter unit 3 is shown below a floor G of the preparation room R7 on the sheet of FIG. 2 in a simplified manner, the fan filter unit 3 is embedded in a wall of a space R12 adjacent to the preparation room R7 with the door Dp therebetween as shown in FIG. 1.

As shown in FIG. 2, the fan filter unit 3 includes an air return fan 3a (second fan) and a filter 3b. The air return fan 3a is an air blower that performs air discharge and air return from the preparation room R7 (clean room). As shown in FIG. 2, the suction side of the air return fan 3a communicates with the chamber C (common space) via the duct shaft DS2.

The filter 3b is a filter that collects dust from air flowing from the preparation room R7 toward the air return fan 3a, and is provided on the suction side of the air return fan 3a. For example, a HEPA or a ULPA is used as the filter 3b described above. Note that, since the filter 3b also functions as a resistance body (air resistance) in flow-out of air from the preparation room R7, maintaining the preparation room R7 at a relatively high room pressure is facilitated. Furthermore, a case (not shown) that houses the air return fan 3a and the filter 10) 3b is fitted to an opening portion in the wall forming the aforementioned space R12 (see FIG. 1), and is fixed with a clasp or the like.

The pressure sensor 31 shown in FIG. 2 is a sensor that detects the room pressure of the preparation room R7 (clean room), and is provided in the preparation room R7. The air supply fans 1a and 2a and the air return fan 3a are controlled such that the room pressure of the preparation room R7 becomes the predetermined target pressure (set pressure). Note that a room pressure of a normal room (not shown) provided outside the clean rooms may be used as a reference pressure in detection of the room pressure of the preparation room R7. Moreover, a detection value of the pressure in the chamber C or a predetermined pressure value set in advance may be used as the reference pressure.

Gaps K1 and K2 shown in FIG. 2 are ventilation passages in the case where air exits the preparation room R7. One gap K1 is, for example, a gap between a floor surface of the preparation room R7 and a packing (not shown) in a lower end portion of the door Dq (see FIG. 1) partitioning the preparation room R7 and a space R13 (see FIG. 1). Note that the space R13 shown in FIG. 1 communicates with the suction side of the air handling unit 50 via the duct shaft DS1 (see FIG. 2). Moreover, the height position of a lower end of the packing of the door Dq is adjustable to allow appropriate adjustment of the size of the gap K1.

The other gap K2 shown in FIG. 2 is, for example, a gap between the floor surface of the preparation room R7 and a packing (not shown) in a lower end portion of the door Dp partitioning the preparation room R7 and the space R12 (see FIG. 1). Note that the space R12 shown in FIG. 1 is provided on the suction side of the air return fan 3a (see FIG. 2), and communicates with the chamber C (see FIG. 2) via the duct shaft DS2 (see FIG. 2). The height position of a lower end of the packing of the door Dp is adjustable to allow adjustment of the size of the gap K2. The sizes (opening ratios) of the gaps K1 and K2 are appropriately adjusted in designing or the test operation of the air conditioning system S, based on the volume of the preparation room R7, the number of times of ventilation per unit time, the target pressure, and the like.

Moreover, in the example of FIG. 2, a thin plate H2 with multiple holes is installed at an upper end of the duct shaft DS2. During the drive of the air supply fans 1a and 2a and the air return fan 3a, part of air that is guided from the preparation room R7 into the duct shaft DS2 via the gap K2 is returned to the chamber C (that is, air return is performed) through the holes of the thin plate H2. Meanwhile, the remaining air guided to a lower portion of the duct shaft DS2 is sucked into the air return fan 3a, and is discharged to the outside.

When the air return fan 3a (second fan) performs the air discharge and the air return from the preparation room R7 (clean room), the suction side of the air supply fan 1a (first fan) and the suction side of the air return fan 3a (second fan) each communicate with the chamber C (common space). Part of air in the preparation room R7 with a high degree of cleanliness can be thereby reused for air conditioning of the clean rooms. Note that, although the air return to the chamber C by the air return fan 3a causes the pressure in the chamber C to slightly 20 change, this has almost no risk of imposing a negative effect on maintaining of the room pressures in the respective clean rooms.

As shown in FIG. 2, the fan filter unit 4 is embedded in the ceiling E of the pre-clean room R9. Moreover, the pressure sensor 32 is provided in the pre-clean room R9. An air supply fan 4a is controlled based on a detection value of the pressure sensor 32 such that the room pressure of the pre-clean room R9 becomes a predetermined target pressure. Note that, although an arrow is shown to penetrate a floor G of the pre-clean room R9 to the lower side on the sheet of FIG. 2, for example, air in the pre-clean room R9 is discharged through a gap between a floor surface of the pre-clean room R9 and a packing (not shown) at a lower end of the door Dw (see FIG. 1). Note that the same applies to the other pre-clean room R8.

The fan filter unit 6 (first unit) including an air supply fan 6a (first fan) and a filter 6b is embedded in the ceiling E of the air lock AL2 shown in FIG. 2. Moreover, the fan filter unit 7 (second unit) including an air return fan 7a (second fan) and a filter 7b is embedded in a side wall of the air lock AL2. The pressure sensor 34 that detects the room pressure is provided in the air lock AL2. The air supply fan 6a and the air return fan 7a are controlled such that the room pressure of the air lock AL2 becomes a predetermined target pressure. Air blown out from the air return fan 7a is returned to the chamber C by being sequentially passed through the duct shaft DS3 and multiple holes in a thin plate H3.

When the air return fan 7a (second fan) performs air return from the air lock AL2 (clean room) and performs no air discharge from the air lock AL2 as described above, the suction side of the air supply fan 6a (first fan) and the blow-out side of the air return fan 7a (second fan) each communicate with the chamber C (common space). Note that, since configurations relating to room pressure adjustment of the other air lock AL1 and the second changing room R6 are the same as that of the air lock AL2, description thereof is omitted. Next, configurations relating to room pressure adjustment of the other rooms that are not shown in FIG. 2 among the rooms shown in FIG. 1 are described by using FIG. 3.

FIG. 3 is an explanatory diagram showing arrangement and the like of multiple fan filter units.

Note that the ceilings E shown in FIG. 3 are the same as those shown in FIG. 2. Moreover, the chamber C shown in FIG. 3 is also the same as that shown in FIG. 2.

A fan filter unit 12 (first unit) shown in FIG. 3 is a device that performs air supply from the chamber C to the first changing room R2 (clean room), and is embedded in the ceiling E. The fan filter unit 12 includes an air supply fan 12a (first fan) and a filter 12b.

A fan filter unit 13 (second unit) is a device that performs air discharge from the first changing room R2 (clean room). As described above, in the example of FIG. 3, the fan filter unit 13 is different from the above fan filter units 3, 7, 9, and 11 (see FIG. 2) in that the fan filter unit 13 is not used for air return. Moreover, although the fan filter unit 13 is shown below a floor G of the first changing room R2 on the sheet of FIG. 3 in a simplified manner, the fan filter unit 13 is embedded in a wall partitioning the first changing room R2 and the outside as shown in FIG. 1.

As shown in FIG. 3, the fan filter unit 13 includes an air discharge fan 13a (second fan) and a filter 13b. Moreover, a pressure sensor 37 for detecting the room pressure is provided in the first changing room R2. The air supply fan 12a and the air discharge fan 13a are controlled such that the room pressure of the first changing room R2 becomes a predetermined target pressure.

Since configurations relating to room pressure adjustment of the dressing-undressing room R1 and the pre-clean rooms R4, R5, and R11 shown in FIG. 3 are the same as that of the pre-clean room R9 (see FIG. 2) described above, description thereof is omitted. Moreover, since a configuration relating to the room pressure adjustment of the undressing room R10 shown in FIG. 3 is the same as that of the first changing room R2 described above, description thereof is omitted.

Fan filter units 20 to 22 are each embedded in the ceiling E of the preprocessing room R3 shown in FIG. 3. The suction side of air supply fans 20a and 21a included in the fan filter units 20 and 21 (first unit) communicate with the chamber C. Meanwhile, the blow-out side of an air discharge fan 22a included in the fan filter unit 22 (second unit) is open to the outside. Moreover, a pressure sensor 43 is provided in the preprocessing room R3. The air supply fans 20a and 21a and the air discharge fan 22a are controlled such that the room pressure of the preprocessing room R3 becomes a predetermined target pressure.

Note that part of air supplied to the preprocessing room R3 by drive of the air supply fans 20a and 21a is discharged by the air discharge fan 22a. Moreover, the remaining air is guided to an air handling unit (not shown) by being sequentially passed through a gap K3, a duct shaft DS6, and a duct D3 shown in FIG. 3. Note that an opening degree of a damper B3 provided in the duct D3 is maintained in a predetermined state set in the test operation or the like.

Note that the “first unit” including the “first fan” that performs air supply to the “clean room” includes the fan filter units 12, 14 to 17, and 19 to 21 shown in FIG. 3 in addition to the fan filter units 1, 2, 4 to 6, 8, and 10 shown in FIG. 2.

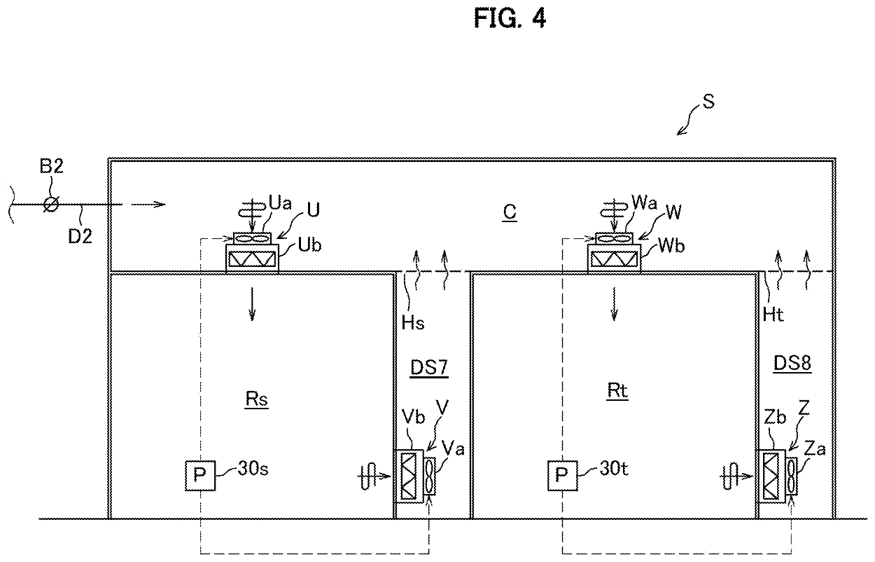

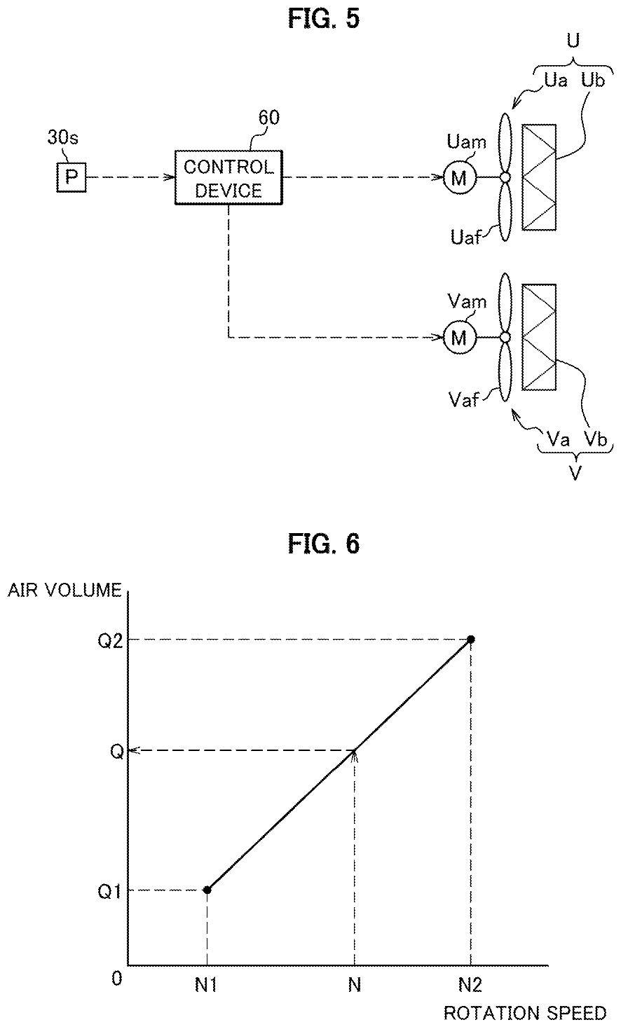

Moreover, the “second unit” including the “second fan” that performs at least one of air discharge and air return from the “clean room” includes the fan filter units 13, 18, and 22 (see FIG. 5) shown in FIG. 3 in addition to the fan filter units 3, 7, 9, and 11 shown in FIG. 2. Next details of the room pressure adjustment in each clean room are described by using FIG. 4.

FIG. 4 is an explanatory diagram of the air conditioning system S.

Note that, in FIG. 4, arbitrary two clean rooms Rs and Rt are extracted and shown from among the multiple clean rooms shown in FIGS. 2 and 3 to facilitate understanding of explanation. Configurations relating to room pressure adjustment of the clean rooms Rs and Rt are the same as those of the second changing room R6 (see FIG. 2) and the air locks AL1 and AL2 (see FIG. 2) described above. Specifically, air sent into the clean room Rs by an air supply fan Ua is returned to the chamber C via a duct shaft DS7 by an air return fan Va.

Note that the same applies to air supply and air return of the other clean room Rt. Moreover, dampers (not shown) as air resistance are provided near upper ends of the duct shafts DS7 and DS8 in some cases.

Note that the following explanation can be applied to the room pressure adjustment of each clean room such as the preparation room R7 (see FIG. 2) in which the air return fan 3a (see FIG. 2) performs both of the air discharge and the air return as well as the first changing room R2 (see FIG. 3) in which the air discharge fan 13a (see FIG. 3) is provided.

A case where one clean room Rs is used as a “positive pressure room” and the other clean room Rt is used as a “negative pressure room” is described below as an example. In this case, the “positive pressure room” is a clean room in which the room pressure is set relatively high to suppress flow-in of air from other adjacent clean rooms through doors. Moreover, a “positive pressure” is a room pressure higher than the reference pressure set in advance.

Meanwhile, the “negative pressure room” is a clean room in which the room pressure is set relatively low to prevent, for example, flow-out of viruses of contagious diseases, radioactive materials, or the like to other adjacent clean rooms through doors when the viruses or the like are handled. Moreover, a “negative pressure” is a room pressure lower than the reference pressure set in advance. Note that a room pressure of a predetermined clean room or a room pressure of a normal room (not shown) other than the clean rooms may be used as the reference pressure of the “positive pressure” and the “negative pressure”.

FIG. 5 is a configuration diagram relating to control of a fan filter unit U on the air supply side and a fan filter unit V on the air return side.

As shown in FIG. 5, the fan filter unit U (first unit) on the air supply side includes the air supply fan Ua (first unit) and a filter Ub. The air supply fan Ua is an air blower that performs air supply to the clean room Rs (see FIG. 4), and includes a fan main body Uaf and a fan motor Uam.

The fan filter unit V (second unit) on the air return side includes the air return fan Va (second fan) and a filter Vb. The air return fan Va is an air blower that performs air return from the clean room Rs (see FIG. 4), and includes a fan main body Vaf and a fan motor Vam.

Note that, for example, axial-flow fans such as propeller fans are used as the fan main bodies Uaf and Vaf. Moreover, for example, DC motors are used as the fan motors Uam and Vam. A pressure sensor 30s shown in FIG. 5 is a sensor that detects the room pressure of the clean room Rs (see FIG. 4), and is provided in the clean room Rs.

A control device 60 (controller) is a device that controls the air supply fan Ua and the air return fan Va. In the example of FIG. 5, the input side of the control device 60 is connected to the pressure sensor 30s via wiring while the output side is connected to the air supply fan Ua and the air return fan Va via wiring. Although not shown, the control device 60 is configured by including a CPU (central processing unit), a ROM (read only memory), a RAM (random access memory), and electronic circuits of various interfaces and the like. The CPU executes various processes by reading a program stored in the ROM and loading the program onto the RAM. Note that the control device 60 may have a configuration including a PLC (programmable logic controller: not shown).

Although FIG. 5 shows the example in which the air supply fan Ua and the air return fan Va are connected to one control device 60, a control device (not shown) of the air supply fan Ua and a control device (not shown) of the air return fan Va may be separately provided. Moreover, one control device may control the air supply fans and the air return fans of multiple clean rooms.

When the clean room Rs (see FIG. 4) is used as the positive pressure room, for example, the control device 60 controls the air return fan Va based on a detection value of the pressure sensor 30s while driving the air supply fan Ua at a constant speed. In this case, driving the air supply fan Ua at the “constant speed” means maintaining the rotation speed of the air supply fan Ua constant irrespective of the detection value of the pressure sensor 30s. When the control device 60 drives the air supply fan Ua at the predetermined rotation speed (fixed value), the control device 60 sets the rotation speed (that is air volume) of the air supply fan Ua such that ventilation of the clean room Rs is performed a predetermined number of times per unit time. The degree of cleanliness of the clean room Rs can be thereby maintained at a predetermined level. Note that the level of “constant” in the “constant speed” does not have to be strictly “constant” as long as it is such a level that the effect is achieved.

Moreover, the control device 60 controls the air return fan Va based on the detection value of the pressure sensor 30s such that the room pressure of the clean room Rs (see FIG. 4) becomes a predetermined target pressure (set pressure). For example, when the room pressure of the clean room Rs exceeds the target pressure, the control device 60 increases the rotation speed of the air return fan Va as predetermined. An air volume of air flowing out from the clean room Rs (see FIG. 4) to the duct shaft DS7 (see FIG. 4) thereby increases. Meanwhile, the air supply fan Ua is driven at the constant speed as described above. As a result, the room pressure that has temporarily increased in the clean room Rs returns to the target pressure.

Meanwhile, when the room pressure of the clean room Rs (see FIG. 4) falls below the target pressure, the control device 60 reduces the rotation speed of the air return fan Va as predetermined. As a result, the room pressure that has temporarily increased in the clean room Rs returns to the target pressure. The control device 60 changing the rotation speed of the air return fan 3a based on the detection value of the pressure sensor 30s as described above maintains the room pressure of the clean room Rs at the predetermined target pressure. When the clean room Rs is used as the positive pressure room, in many cases, it is better that the speed of the air supply fan Ua is set to the constant speed while the speed of the air return fan Va is set to the variable speed based on the room pressure as described above.

FIG. 6 is a characteristic diagram showing a relationship between the rotation speed and the air volume of the air return fan.

Note that the horizontal axis of FIG. 6 represents the rotation speed of the air return fan Va (see FIG. 5), and the vertical axis represents the air volume of the air return fan Va. As shown in FIG. 6, the higher the rotation speed of the air return fan Va is, the larger the air volume thereof is. Moreover, since, for example, a DC motor is used as the fan motor Vam (see FIG. 5) of the air return fan Va, the rotation speed and the air volume thereof have a linear relationship (proportional relationship). Accordingly, there is such an advantage that fine adjustment of the air volume is easier to perform by using the air return fan Va, compared to the case where the air volume adjustment is performed by using a damper (not shown) in which an opening degree-air volume characteristic is a non-linear relationship. Note that, in addition to the air return fan Va, the air supply fan Ua (see FIG. 5) also has the same characteristic as FIG. 6.

A lower limit value N1 of the rotation speed shown in FIG. 6 and a lower limit value Q1 of the air volume corresponding to the lower limit value N1 are set in advance in the air return fan Va (see FIG. 5). Similarly, an upper limit value N2 of the rotation speed of the air return fan Va and an upper limit value Q2 of the air volume corresponding to the upper limit value N2 are also set in advance. Particularly, focusing on the lower limit value Q1 of the air volume of the air return fan Va, a specific numerical value example thereof is 50 [m³/h], and is about one third of a lower limit value (about 150 [m³/h]) of an air volume in the case where the air volume adjustment is performed by using a conventional damper (not shown). As described above, since the rotation speed-air volume characteristic of the air return fan Va is the linear relationship, the control device 60 can finely adjust the air volume of the air return fan Va near the lower limit value Q2. Accordingly, it is possible to accurately adjust the room pressure and greatly reduce a power consumption amount of the air conditioning system S (see FIG. 4) compared to the case where the air volume adjustment is performed by using the damper (not shown).

Next, control in the case where the clean room Rt shown in FIG. 4 is used as the negative pressure room is described. When the clean room Rt is used as the negative pressure room, for example, the control device 60 (see FIG. 5) controls an air supply fan Wa (see FIG. 4) based on a detection value of a pressure sensor 30t (see FIG. 4) while driving an air return fan Za (see FIG. 4) at a constant speed. Note that, since a rotation speed-air volume characteristic of the air supply fan Wa is also linear (see FIG. 6), fine adjustment of the rotation speed of the air supply fan Wa near the lower limit value Q1 (see FIG. 6) of the air volume can be easily performed. Accordingly, it is possible to accurately maintain the room pressure of the clean room Rt while reducing the power consumption amount of the air conditioning system S (see FIG. 4).

Note that, when the clean room Rt is used as the negative pressure room, in many cases, it is better that the speed of the air supply fan Wa is set to the variable speed based on the room pressure while the speed of the air return fan Za is set to the constant speed, in consideration of the volume of the clean room Rt, the target values of the degree of cleanliness and the room pressure, the performances of the air supply fan Wa and the air return fan Za, and the like.

Moreover, for example, there is a case where the clean room Rs shown in FIG. 4 has been used as the positive pressure room, but a user desires to change the application thereof and use the clean room Rs as the negative pressure room from a certain time point. In such a case, the control device 60 performs switching to control the air supply fan Ua, which has been driven at the constant speed up to this point, based on the detection value of the pressure sensor 30s, and drive the air return fan Va, which has been driven at the variable speed up to this point, at the constant speed.

Furthermore, for example, there is a case where the other clean room Rt shown in FIG. 4 has been used as the negative pressure room, but a user desires to change the application thereof and use the clean room Rt as the positive pressure room from a certain time point. In such a case, the control device 60 performs switching to drive the air supply fan Wa, which has been driven at the variable speed up to this point, at the constant speed and control the air return fan Za, which has been driven at the constant speed up to this point, based on the detection value of the pressure sensor 30t.

As described above, the control device 60 (controller) controls one of the air supply fan Ua (first fan) and the air return fan Va (second fan) based on the detection value of the pressure sensor 30s, and controls the other at the constant speed. Moreover, the control device 60 is configured such that the fan controlled based on the detection value of the pressure sensor 30s and the fan controlled at the constant speed out of the air supply fan Ua and the air return fan Va can be switched. In other words, the room pressure of the clean room Rs can be switched from one of the positive pressure and the negative pressure to the other. Note that the aforementioned “switching” may be performed by a user operation made through input means (not shown).

The clean room Rs can be thereby selectively used as the positive pressure room or the negative pressure room depending on the application thereof. The same applies to the other clean room Rt. Accordingly, work load and cost can be greatly reduced from those in the case where a clean room of the positive pressure room or the negative pressure rooms is additionally provided.

Note that, when the clean room Rs is switched from one of the positive pressure room and the negative pressure room to the other, the control device 60 may temporarily stop the air supply fan Ua and the air return fan Va and then drive the air supply fan Ua and the air return fan Va again. Alternatively, the control device 60 may switch the control method of each of the air supply fan Ua and the air return fan Va while continuously driving the fan.

### <Effects>

According to the first embodiment, the fan controlled based on the detection value of the pressure sensor 30s (see FIG. 4) and the fan controlled at the constant speed out of the air supply fan Ua (see FIG. 4) and the air return fan Va (see FIG. 4) are configured to be switchable. Accordingly, one clean room Rs can be selectively used as the positive pressure room or the negative pressure room. Thus, the air conditioning system S with good usability for the user can be provided. Moreover, since the work load and the cost can be greatly reduced from those in the case where a clean room (not shown) of the positive pressure room or the negative pressure room is additionally provided, this embodiment can contribute to society.

Moreover, since there is no need to particularly provide ducts (not shown) that guide air to the clean rooms Rs and Rt and ducts (not shown) that guide air from the clean rooms Rs and Rt to the outside, the configuration of the air conditioning system S can be simplified.

Furthermore, it is possible reduce a construction period in installation of the air conditioning system S and reduce cost required for the installation from those in the case where the ducts (not shown) are provided in the chamber C (or are provided instead of the chamber C).

Moreover, in the configuration in which the room pressure is adjusted with the damper (not shown) provided in the duct (not shown) as in a conventional technique, response delay and overshoot tend to occur in the room pressure adjustment of the clean room due to pressure loss of air in the duct, the non-linearity of the opening degree-air volume characteristic of the damper, and the like. Meanwhile, in the first embodiment, for example, since the room pressure of the clean room Rs (see FIG. 4) is adjusted with the air return fan Va or the air supply fan Ua, the aforementioned pressure loss or response delay hardly occurs. Moreover, since the rotation speed-air volume characteristic of the air return fan Va and the air supply fan Ua is linear (see FIG. 6), the room pressure of the clean room Rs can be accurately maintained. Note that the same applies to each of the other clean rooms.

### Second Embodiment

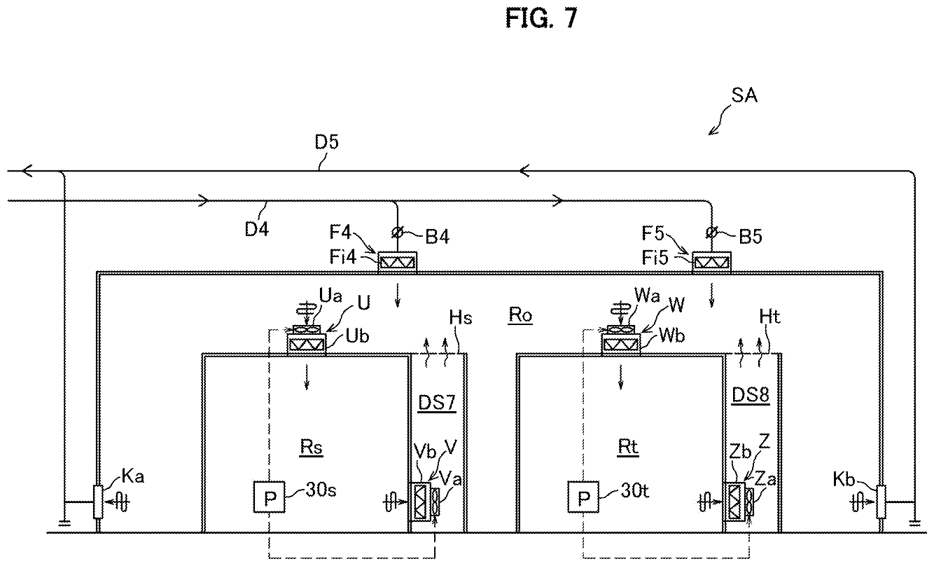

A second embodiment is different from the first embodiment in that no chamber is particularly provided above the ceilings of the clean rooms. Moreover, the second embodiment is different from the first embodiment in that the two clean rooms Rs and Rt (see FIG. 7) are provided in a large room Ro (see FIG. 7) that is relatively large. Note that the configurations and control of the fan filter units U and W on the air supply side and the fan filter units V and Z on the air return side are the same as those in the first embodiment (see FIGS. 4 and 5). Moreover, the point that the control device 60 can switch each of the clean rooms Rs and Rt from one of the positive pressure room or the negative pressure room to the 20 other is also the same as in the first embodiment. Accordingly, portions different from the first embodiment are described, and description of overlapping portions is omitted.

FIG. 7 is an explanatory diagram of an air conditioning system SA according to the second embodiment.

In the example of FIG. 7, the two clean rooms Rs and Rt are provided in the large room Ro. A filter unit F4 is provided in a ceiling of the large room Ro. The filter unit F4 is a filter unit that collects dust from air flowing through a duct D4. For example, a HEPA or a ULPA is used as the filter unit F4 described above. Air that has passed through the filter unit F4 is guided to a space of the large room Ro. Note that a damper B4 is provided near the filter unit F4 in the duct D4. For example, the damper B4 is set to a predetermined opening degree in a test operation of the air conditioning system SA, and is maintained at the above predetermined opening degree during an air conditioning operation after the test operation.

Gaps Ka and Kb shown in FIG. 7 are ventilation passages in the case where air flows out from the large room Ro. Air is guided to an air handling unit (not shown) by being sequentially passed through the gaps Ka and Kb and a duct D5. Air whose temperature and the like are adjusted in the air handling unit (not shown) is returned to the large room Ro via the different duct D4.

As shown in FIG. 7, the fan filter unit U (first unit) on the air supply side is provided in the ceiling of the clean room Rs. Moreover, the fan filter unit V (second unit) on the air return side is provided in the side wall of the clean room Rs. The air guided to the clean room Rs via the air supply fan Ua is then returned to the space of the large room Ro by being sequentially passed through the air return fan Va and the duct shaft DS7. Note that the same applies to the other clean room Rt.

As shown in FIG. 7, when the air return fan Va (second fan) performs air return from the clean room Rs and performs no air discharge from the clean room Rs, the suction side of the air supply fan Ua (first fan) and the blow-out side of the air return fan Va (second fan) communicate with the space (common space) of the large room Ro.

The control device 60 (see FIG. 5) is configured such that the fan controlled based on the detection value of the pressure sensor 30s and the fan controlled at the constant speed out of the air supply fan Ua (first fan) and the air return fan Va (second fan) can be switched. The clean room Rs can be thereby selectively used as the positive pressure room or the negative pressure room. Note that, since the room pressure adjustment of the clean rooms Rs and Rt is the same as that in the first embodiment, description thereof is omitted.

### <Effects>

According to the second embodiment, also in the configuration in which the clean rooms Rs and Rt are provided in the large room Ro, each of the clean rooms Rs and Rt can be selectively used as the positive pressure room or the negative pressure room. Thus, the air conditioning system SA with good usability for the user can be provided. Moreover, the work load and the cost can be greatly reduced from those in the case where a clean room of the positive pressure room or the negative pressure room is additionally provided.

### Modified Examples

The air conditioning systems S and SA according to the present invention have been described above by using the embodiments. However, the present invention is not limited to the description of these embodiments, and various changes can be made.

For example, in each embodiment, setting of the rotation speed in the case where the air supply fan Ua (see FIG. 5) or the air return fan Va (see FIG. 5) is controlled at the constant speed is not particularly mentioned. This setting may be as follows. Specifically, the air volume of the fan controlled at the constant speed out of the air supply fan Ua (first fan) and the air return fan Va (second fan) may be set based on the target pressure of the clean room Rs. Note that the setting of the air volume of the fan controlled at the constant speed may be performed by the control device 60 or performed based on a user operation made through input means (not shown).

As a specific example, when the air supply fan Ua is to be controlled at the constant speed, the control device 60 sets the air volume of the air supply fan Ua such that the higher the target pressure of the clean room Rs is, the higher the air volume is. Moreover, when the air return fan Va is to be controlled at the constant speed, the control device 60 sets the air volume of the air return fan Va such that the higher the target pressure of the clean room Rs is, the lower the air volume is. The room pressure can be thereby brought closer to the target pressure more easily when the clean room Rs is used as the positive pressure room or the negative pressure room.

Moreover, in each embodiment, description is given of the case where, when the clean room Rs (see FIG. 4) is to be used as the positive pressure room, the control device 60 drives the air supply fan Ua at the constant speed while driving the air return fan Va at the variable speed based on the room pressure. However, the present invention is not limited to this. Specifically, when the clean room Rs is used as the positive pressure room, it is sometimes preferable to drive the air supply fan Ua at the variable speed based on the room pressure while driving the air return fan Va at the constant speed, depending on a usage condition.

Furthermore, in each embodiment, description is given of the case where, when the clean room Rs (see FIG. 4) is used as the negative pressure room, the control device 60 drives the air supply fan Ua at the variable speed based on the room pressure while driving the air return fan Va at the constant speed. However, the present invention is not limited to this. Specifically, when the clean room Rs is used as the negative pressure room, it is sometimes preferable to drive the air supply fan Ua at the constant speed while driving the air return fan Va at the variable speed based on the room pressure, depending on a usage condition.

Moreover, the first embodiment and the second embodiment can be combined as appropriate. For example, instead of the air return fan Va (see FIG. 4) described in the second embodiment, an air return fan (not shown) that performs air discharge and air return from the clean room Rs (see FIG. 4) may be provided. When the air return fan (second fan) performs air discharge and air return from the clean room Rs as described above, the suction side of the air supply fan (first fan) and the suction side of the air return fan (second fan) each communicate with the space (common space) of the large room Ro. This allows part of clean air in the clean room Rs to return to the space of the large room Ro while discharging the remaining air. Moreover, in the above configuration, the fan controlled based on the detection value of the pressure sensor 30s and the fan controlled at the constant speed out of the air supply fan (first fan) and the air return fan (second fan) may be switchable. This allows the clean room Rs to be selectively used as the positive pressure room or the negative pressure room.

In addition, for example, instead of the air return fan Va described in the second embodiment, an air discharge fan (not shown) that discharges air from the clean room Rs may be provided. In such a configuration, the fan controlled based on the detection value of the pressure sensor 30s and the fan controlled at the constant speed out of the air supply fan (first fan) and the air discharge fan (second fan) may be switchable. This allows the clean room Rs to be selectively used as the positive pressure room or the negative pressure room.

Moreover, in each embodiment, the case where the air conditioning systems S and SA are used in the regenerative medicine facility is described as an example. However, the present invention is not limited to this. Specifically, the embodiments may also be applied to various other fields such as manufacturing of industrial products, food industries, production of drugs, and the like.

Furthermore, each embodiment is described in detail to explain the present invention in an easily understandable manner, and the present invention is not necessarily limited to the embodiments including all described configurations. Moreover, some of the configurations in the embodiment may be deleted or replaced, or other configurations may be added thereto.

Furthermore, mechanisms and configurations assumed to be necessarily for the explanation are shown as the mechanisms and configurations described above, and not all of mechanisms and configurations necessary as a product are shown.

### REFERENCE SIGNS LIST

1, 2, 4, 5, 6, 8, 10, 12, 14, 15, 16, 17, 19, 20, 21, U, W fan filter unit (first unit)
3, 7, 9, 11, 13, 18, 22, V, Z fan filter unit (second unit)
1a, 2a, 4a, 5a, 6a, 8a, 10a, 12a, 14a, 15a, 16a, 17a, 19a, 20a, 21a, Ua, Wa air supply fan (first fan)
3a, 7a, 9a, 11a, Va, Za air return fan (second fan)
13a, 18a, 22a air discharge fan (second fan)
31, 32, 33, 34, 35, 36, 37, 38, 39, 40, 41, 42, 43, 30s, 30t pressure sensor
60 control device (controller)
C chamber (common space)
AL1, AL2 air lock (clean room)
R1 dressing-undressing room (clean room)
R2 first changing room (clean room)
R3 preprocessing room (clean room)
R4, R5, R8, R9, R11 pre-clean room (clean room)
R6 second changing room (clean room)
R7 preparation room (clean room)
R10 undressing room (clean room)
Rs, Rt clean room
Ro large room (common space)
S, SA air conditioning system

1.-5. (canceled)

6. An air conditioning system comprising:
a first unit including a first fan that performs air supply to a clean room provided inside a predetermined room and a first filter that is provided on a blow-out side of the first fan;
a second unit including a second fan that performs air return from the clean room; and
a duct shaft that guides air from the clean room to the predetermined room, wherein
the duct shaft extends in an up-down direction, and an upper end of the duct shaft is opened, and
the air guided to the clean room through the first fan is returned to the predetermined room by being sequentially passed through the second fan and the duct shaft.

7. The air conditioning system according to claim 6, further comprising a filter unit provided in a ceiling of the predetermined room, wherein
the first unit is arranged below the filter unit.

8. The air conditioning system according to claim 6, wherein, air whose temperature is adjusted by an air handling unit is supplied to the predetermined room.

9. The air conditioning system according to claim 6, further comprising:
a pressure sensor provided in the clean room; and
a controller that controls one of the first fan and the second fan based on a detection value of the pressure sensor and controls the other one of the first fan and the second fan at a constant speed, wherein
the fan controlled based on the detection value of the pressure sensor and the fan controlled at the constant speed out of the first fan and the second fan are switchable.

10. The air conditioning system according to claim 6, further comprising:
a pressure sensor provided in the clean room; and
a controller capable of switching a room pressure of the clean room from one of a positive pressure and a negative pressure to the other.
